(19) United States
(12) Patent Application Publication
(10) Pub. No.: US 2025/0242420 A1
(43) Pub. Date: Jul. 31, 2025

(54) METHOD AND SYSTEM FOR IDENTIFICATION OF KEY BLANK PART NUMBERS

(71) Applicant: CLK Supplies, LLC, Hayden, ID (US)

(72) Inventor: Peter Slauson, JR., Rathdrum, ID (US)

(73) Assignee: CLK Supplies, LLC, Hayden, ID (US)

(21) Appl. No.: 18/428,993

(22) Filed: Jan. 31, 2024

(51) Int. Cl. B23C 3/35; G06N 20/00; G06T 7/00

(52) U.S. Cl. CPC B23C 3/35; G06N 20/00; G06T 7/0004; B23C 2235/12; B23C 2235/41

(57) ABSTRACT

One or more machine learning models are trained to search an image database to find images that are visually similar to images of cut keys, and a key blank identification system, which utilizes the trained machine learning models, is provided to a user. The user uploads one or more images of a cut key, the trained machine learning models identify one or more key blank part numbers that match with the cut key images, and the results are presented to the user. The user provides feedback relating to the accuracy of the results, and the feedback data is incorporated into the trained machine learning model to refine the model.

### BACKGROUND

In everyday life, lock and key hardware mechanisms are utilized globally for keeping a wide variety of buildings, rooms, vehicles, storage containers, and other objects secure from theft, damage, or misuse. The uniquely cut keys that are used to open locking mechanisms are created by cutting notches and grooves, sometimes called teeth, along one or more portions of a shaped piece of metal, referred to in the lock and key industry as a key blank. Due to the wide variety of uses for lock and key hardware mechanisms, the key blanks that are used as a base for producing unique cut keys are manufactured in many different styles, with each style having a unique combination of properties, such as shape, size, and milling.

While certain styles of key blanks may be relatively common in one country, common styles of key blanks in other countries may vary significantly. Due to the fact that we now live in a global economy, there are currently a vast number of key blank styles corresponding to the millions of cut keys that may be used daily in any given country. Further, a significantly large number of new key blank styles are currently being manufactured worldwide every year. The significant increase in recent years of the number of key blank styles that correspond to existing cut keys poses a serious problem for a variety of individuals who need to identify which styles of key blank correspond to, or match with, individual uniquely cut keys.

For example, it is very often the case that an individual in possession of a uniquely cut key will need to obtain a physical copy of the cut key, for any number of reasons. Typically, in order to obtain a physical copy of the cut key, the individual will need to bring the cut key to a lock and key professional, such as a locksmith, or to an employee of a store that provides lock and key services, such as a hardware or general goods store.

In order for a provider of lock and key services to duplicate the cut key, they first need to identify the key blank that matches with the cut key. While some keys have numbers or markings on the head, which one might mistake for being identifying information, in actuality, these markings typically mean nothing in terms of identifying the key blank that they key was cut from. Currently and historically, there are only a few known methods for an individual to identify key blanks that correspond to cut keys. One method is for the individual to memorize every key ever made, which is clearly beyond the capability of the human mind, and thus is not a feasible or practical option. Another method involves use of an expensive and bulky key reading machine, which has also been found to be an impractical solution. Another method, which is the primary method currently being used, is for the individual to page through large numbers of images of key blanks in a printed key blank manufacturing book to find the key blank that matches with the cut key, which is a process that is time-intensive and typically requires specialized industry knowledge. Further, not all manufacturers make all types of key blanks and so sometimes the individual must consult several different manufacturing books to locate the correct key blank.

In addition to the above-mentioned drawbacks of using the traditional methods for identifying key blanks, the printed key blank manufacturing books relied on by individuals for identifying key blanks are typically extremely outdated. As one example, in the United States, there are two main key blank manufacturing books that are utilized for this purpose, which at one point, had not been updated for over twelve years. Considering the fact, noted above, that a significantly large number of new key blank styles are manufactured worldwide every year, the number of key blank styles that cannot even be found in the key blank manufacturing books is considerable.

Without the use of printed key blank manufacturing books, an individual would have to resort to using internet searches to guess the key blank part number based solely on the individual's industry experience, which in many cases may be rather minimal. It has been shown, however, that even the most competent locksmiths, having over 40 years of experience in the industry, would likely not be able to correctly guess the key blank style that matches with a particular cut key in any reasonable amount of time. As noted above, memorizing every key ever made is clearly beyond the capability and mental capacity of the human mind, regardless of an individual's experience in the industry.

The result is that many lock and key businesses are consistently losing money on one of the most common customer requests. For example, a lock and key business may only be able to sell a duplicate key for $3.99, while an employee is being paid significantly more by the hour for the labor involved in identifying the key. Thus, not only is the business losing money on the key duplication transaction, the business is also losing money because the excessive time spent by the employee on the transaction potentially prevents the employee from using that time to complete more lucrative tasks.

Additionally, the business is also at risk of losing or upsetting customers who may feel that the wait time for a key duplication transaction is excessive and not justified. Further still, if the employee of the business is reduced to needing to guess the correct key blank part number, for example if the key blank is not in the most current version of the key blank manufacturing books, the employee may end up using the wrong key blank, resulting the customer receiving a key that is not actually functional for its intended purpose, which is clearly a waste of time and resources.

Thus, the shortcomings inherent in the traditional methods for identifying key blanks that correspond with cut keys present a technical problem for lock and key businesses, for employees of lock and key businesses, and for customers of lock and key businesses.

What is needed therefore is a technical solution to the long-standing technical problem of rapidly, easily, efficiently, and accurately identifying key blank part numbers that match with individual uniquely cut keys, including keys that are newly introduced to the market over time.

### SUMMARY

Embodiments of the present disclosure provide a technical solution to the long-standing technical problem of rapidly, easily, efficiently, and accurately identifying key blank part numbers that match with individual uniquely cut keys, including keys that are newly introduced to the market over time.

In one embodiment, the technical solution disclosed herein includes a method and system for identification of key blank part numbers using machine learning models, which provides a user with a powerful tool to rapidly, easily, efficiently, and accurately identify key blank part numbers that match with any number of uniquely cut keys. The system and method disclosed herein eliminates the need for reliance on outdated key blank manufacturing books, bulky and expensive equipment, and error-prone guesswork. Utilizing the methods and systems disclosed herein, the lowest trained employee of a business, on their first day of work, would have the ability to identify key blank part numbers more rapidly, easily, efficiently, and accurately than an industry veteran with over 40 years of experience who uses traditional methods. Thus, the system and method disclosed herein performs tasks that can't be reasonably accomplished using human resources and current methods, which results in major benefits for lock and key businesses, in the form of reduced overhead costs, more efficient use of human resources, and increased reputation among customers.

In various embodiments, one or more machine learning models are trained to search an image database to find images that are visually similar to images of cut keys, and a key blank identification system, which utilizes the trained machine learning models, is provided to a user. In one embodiment, the user uploads one or more images of a cut key, the trained machine learning models identify one or more key blank part numbers that match with the cut key images, and the results are presented to the user. In one embodiment, the user provides feedback relating to the accuracy of the results, and the feedback data is incorporated into the trained machine learning model to refine the model. In one embodiment, the user is given the option to purchase one or more of the identified key blanks. In one embodiment, the user obtains at least one of the matching key blanks and cuts the key blank to generate a duplicate of the original cut key.

In one embodiment, a computer-implemented method for identifying key blank part numbers comprises providing a user with a user interface to a key blank identification system, receiving one or more images of a cut key from the user through the user interface of the key blank identification system, and providing the one or more images of the cut key to a trained key blank identification machine learning model. In one embodiment, the computer-implemented method for identifying key blank part numbers further comprises using the trained key blank identification machine learning model to identify one or more key blank part numbers for one or more key blanks that match the cut key, retrieving one or more images of the one or more matching key blanks from a key image database based on the identified one or more key blank part numbers, and displaying the one or more images of the one or more matching key blanks and the corresponding matched key blank part numbers to the user through the user interface of the key blank identification system. In one embodiment, the computer-implemented method for identifying key blank part numbers further comprises providing the user with one or more mechanisms to obtain one or more physical key blanks corresponding to one or more of the matched key blank part numbers.

In one embodiment, the key blank identification system includes an application provided to the user on a mobile device associated with the user. In one embodiment, the one or more images of the cut key received from the user include an image of a first surface of the cut key and an image of a second surface of the cut key.

In one embodiment the trained key blank identification machine learning model utilizes one or more image similarity algorithms to identify similarities between images of cut keys and images of key blanks. In one embodiment, the trained key blank identification machine learning model utilizes one or more weighting parameters to rank potential key blank matches. In one embodiment similarities between portions of key images depicting the key bottom are weighted more heavily than similarities between portions of key images depicting the key head. In one embodiment, similarities between portions of key images depicting the key bottom are weighted at 90% and similarities between portions of key images depicting the key head are weighted at 10%.

In one embodiment, upon displaying the one or more images of the one or more matching key blanks and the corresponding matching key blank part numbers to the user, confirmation as to whether one of the matched key blank part numbers is the correct key blank part number is requested from the user, and confirmation that one of the matched key blank part numbers is the correct key blank part number is received from the user. In one embodiment, upon receiving confirmation that one of the matched key blank part numbers is the correct key blank part number, one or more images in the key image database are annotated with the correct key blank part number. In one embodiment, upon receiving confirmation that one of the matched key blank part numbers is the correct key blank part number, the user is provided with one or more mechanisms to obtain one or more physical key blanks corresponding to the correct key blank part number.

In one embodiment, upon providing the user with one or more mechanisms to obtain one or more physical key blanks corresponding to the correct key blank part number, at least one of the physical key blanks corresponding to the correct key blank part number is obtained by the user, and at least one of the obtained physical key blanks is cut by the user to produce a duplicate of the cut key.

In one embodiment, a computer-implemented method for identifying key blank part numbers includes aggregating a plurality of images of one or more cut keys, storing the plurality of images of one or more cut keys in a key image database, aggregating a plurality of images of one or more key blanks, wherein each of the key blanks correspond to at least one of the one or more cut keys, and storing the plurality of images of one or more key blanks in the key image database.

In one embodiment, a computer-implemented method for identifying key blank part numbers further includes generating key blank identification training data by annotating one or more images of the plurality of images of cut keys with a unique key blank part number, and generating a trained key blank identification machine learning model by training the one or more machine learning models to identify key blanks using the key blank identification training data, wherein the trained key blank identification machine learning model utilizes one or more image similarity algorithms to identify similarities between images of cut keys and images of key blanks.

In one embodiment, a computer-implemented method for identifying key blank part numbers further includes requesting feedback from the user through a user interface of the key blank identification system, wherein the feedback indicates whether one of the one or more matching key blank part numbers is a correct key blank part number, and upon user indication of a correct key blank part number, annotating the one or more images of the particular cut key with the correct key blank part number. In one embodiment, a computer-implemented method for identifying key blank part numbers further includes storing the one or more annotated images in the key image database and incorporating the one or more annotated images of the particular cut key into the key blank identification training data to generate a refined trained key blank identification machine learning model. In one embodiment, the refined key blank identification machine learning model is utilized to identify unique key blank part numbers that correspond with a plurality of cut keys.

In one embodiment, a system for identifying key blank part numbers includes a key image database, one or more machine learning models, a key blank identification application, at least one processor, and at least one memory, the at least one memory including instructions that when executed by the at least one processor perform one ore more operations of the above-described method.

Consequently, the disclosed embodiments include a method and system for identification of key blank part numbers using machine learning models, which provides a user with a powerful tool for accurately identifying key blank part numbers that match with any number of uniquely cut keys in a small fraction of the time that it takes professionals when utilizing the traditional systems and methods discussed above. Thus, the method and system disclosed herein is capable of achieving performance beyond what a human being is capable of providing. Further, the method and system disclosed herein eliminates the need for reliance on outdated key blank manufacturing books, bulky and expensive equipment, and human limitations, such as error-prone guesswork, resulting in major benefits for lock and key businesses in the form of reduced overhead costs, more efficient use of human resources, and increased reputation among customers. Therefore, embodiments of the present disclosure provide a technical solution to the long-standing technical problem of rapidly, easily, efficiently, and accurately identifying key blank part numbers that match with individual uniquely cut keys, including keys that are newly introduced to the market over time.

### BRIEF DESCRIPTION OF THE DRAWINGS

FIG. 1 is a diagram of a system for identification of key blank part numbers using machine learning models in accordance with one embodiment.

FIG. 2A is an illustrative example of a cut key that may be obtained by a user for identification, in accordance with one embodiment.

FIG. 2B is an illustrative example of a key blank that corresponds to the cut key of FIG. 2A, in accordance with one embodiment.

FIG. 3 is an illustrative example of a variety of key images in a key image database in accordance with one embodiment.

FIG. 4 is an exemplary screenshot of a portion of a cut key image annotation module, in accordance with one embodiment.

FIG. 5A and FIG. 5B are illustrative examples of the distinct portions of a single sided cut key in accordance with one embodiment.

FIG. 6A and FIG. 6B are illustrative examples of the distinct portions of a single sided key blank in accordance with one embodiment.

FIG. 7A and FIG. 7B are illustrative examples of the distinct portions of a double-sided cut key in accordance with one embodiment.

FIG. 8A and FIG. 8B are illustrative examples of the distinct portions of a double-sided key blank in accordance with one embodiment.

FIG. 9A and FIG. 9B are illustrative examples of a cut key/key blank pair with differently shaped heads, in accordance with one embodiment.

FIG. 9C is an illustrative example of a key with a distinctive key head, in accordance with one embodiment.

FIG. 10A through FIG. 10L are screenshots of an exemplary user interface for identifying key blank part numbers, in accordance with one embodiment.

FIG. 11A and FIG. 11B are illustrative examples of portions of a module for annotating cut key images, in accordance with one embodiment.

FIG. 12 is a simplified end user/backend flow diagram of a method for identification of key blank part numbers using machine learning models, in accordance with one embodiment.

FIG. 13 is a flow chart of a method for identification of key blank part numbers using machine learning models, in accordance with one embodiment.

FIG. 14 is a flow chart of a method for training machine learning models and utilizing the trained machine learning models for identification of key blank part numbers, in accordance with one embodiment.

Common reference numerals are used throughout the figures and the detailed description to indicate like elements. One skilled in the art will readily recognize that the above figures are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, or described below. Rather, these exemplary embodiments are provided to allow a complete disclosure that conveys the principles of the invention, as set forth in the claims, to those of skill in the art.

As noted above, in various embodiments, the technical solution disclosed herein includes a method and system for identification of key blank part numbers using machine learning models, which provides a user with a powerful tool to rapidly, easily, and accurately identify key blank part numbers that match with any number of uniquely cut keys. Thus, the method and system disclosed herein is capable of achieving performance beyond what a human being is capable of providing. Further, the system and method disclosed herein eliminates the need for reliance on outdated key blank manufacturing books, bulky and expensive equipment, and error-prone guesswork, resulting in major benefits for lock and key businesses, in the form of reduced overhead costs, more efficient use of human resources, and increased reputation among customers.

As will be discussed in additional detail below, in various embodiments, a user is provided with a key blank identification system, which allows the user to upload one or more images of a physical cut key. In one embodiment, the cut key images are provided to a trained key blank identification machine learning model, which has been trained to search an image database to find images that are visually similar to the user-provided cut key images. In one embodiment, the trained key blank identification machine learning model identifies one or more potential key blank part numbers that match with the user-provided cut key images. In one embodiment, the user is presented with the one or more matched key blank part numbers, and the user is able to provide feedback to the key identification system as to which, if any, of the matched key blank part numbers is the correct key blank part number. In one embodiment, the feedback data is incorporated into the trained key blank identification machine learning model to refine the model. In one embodiment, the user is given the option to purchase one or more of the identified key blanks. In one embodiment, upon receipt of the correct key blank part number, the user obtains at least one of the key blanks identified by the key blank part number and is able to cut the key blank to generate a duplicate of the original physical cut key.

### System

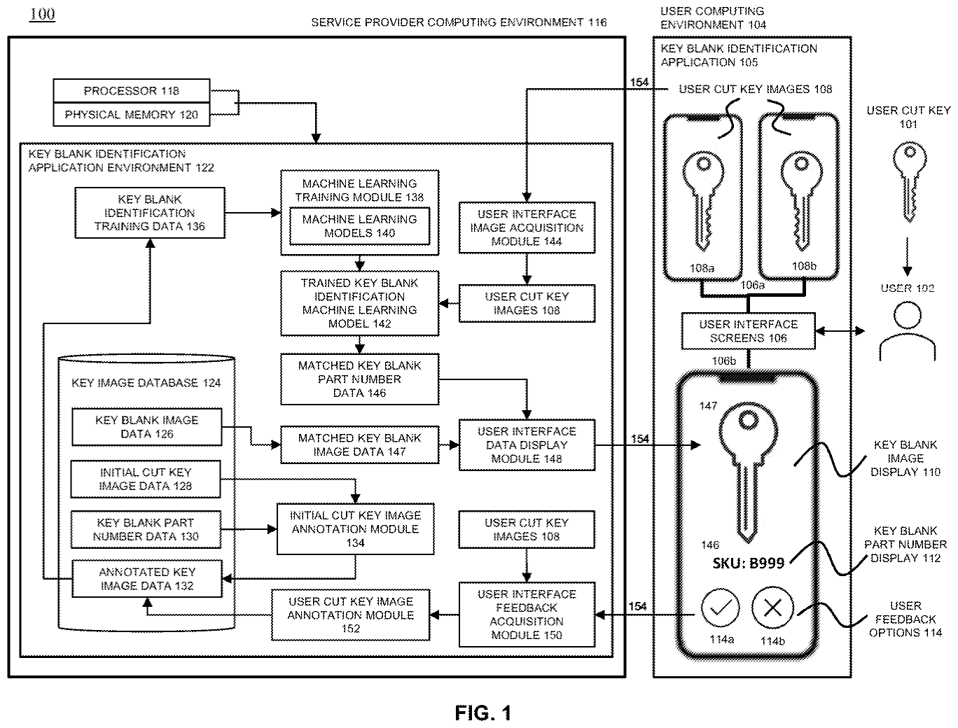

FIG. 1 is a diagram of a system for identification of key blank part numbers using machine learning models in accordance with one embodiment.

In one embodiment, system 100 includes user cut key 101, user 102, user computing environment 104, and service provider computing environment 116. In one embodiment, user computing environment 104 is communicatively coupled to service provider computing environment 116 by one or more communication networks 154.

In one embodiment, service provider computing environment 116 includes one or more processors represented by processor 118, one or more physical memories represented by physical memory 120, and key blank identification application environment 122. In one embodiment, processor 118 and physical memory 120 coordinate the operation and interaction of the data and data processing modules associated with key blank identification application environment 122, as discussed herein.

In one embodiment, key blank identification application environment 122 includes user interface image acquisition module 144, user cut key images 108, user interface data display module 148, and user interface feedback acquisition module 150. In one embodiment, key blank identification application environment 122 includes initial cut key image annotation module 134, user cut key image annotation module 152, key blank identification training data 136, machine learning training module 138, machine learning models 140, trained key blank identification machine learning model 142, matched key blank part number data 146, and matched key blank image data 147. In one embodiment, key blank identification application environment 122 includes key image database 124, which further includes key blank image data 126, initial cut key image data 128, key blank part number data 130, and annotated key image data 132. Each of the above listed elements will be discussed in further detail below.

In one embodiment, user computing environment 104 includes key blank identification application 105, which further includes user interface screens 106. In one embodiment, user interface screens 106 include one or more user input screens 106a. In one embodiment, user input screens 106a are utilized to provide user cut key images 108 to user interface image acquisition module 144. In one embodiment, user cut key images 108 include cut key first surface image 108a and cut key second surface image 108b. Each of the above listed elements will be discussed in further detail below.

In one embodiment, user interface screens 106 include one or more results output screens, represented by results output screen 106b. In one embodiment, results output screen 106b includes key blank image display 110, key blank part number display 112, and user feedback options 114. In one embodiment, key blank image display 110 of results output screen 106b displays matched key blank image data 147. In one embodiment, key blank part number display 112 displays matched key blank part number data 146. In one embodiment, user feedback options 114 includes affirmative feedback button 114a and negative feedback button 114b. Each of the above listed elements will be discussed in further detail below.

As used herein, the term “user” refers to any individual that utilizes the method and system disclosed herein to identify a cut key. In some embodiments, the user may be an individual that is not associated with a lock and key business, such as an owner of a key that is to be identified, or an individual in possession of a key that is to be identified. However, more typically, in other embodiments, the user is a lock and key professional, such as a locksmith, or an employee of a store that provides lock and key services, such as, but not limited to a hardware store or a general goods store. In one embodiment, user 102 may be the owner of one or more cut keys, such as user cut key 101. In other embodiments, user cut key 101 may be brought to user 102 by a third party, such as a customer, for identification.

As discussed above, in the lock and key industry, key identification entails matching a particular cut key with the key blank that the cut key was originally cut from. Key blanks are typically identified by a unique key blank part number that is used to distinguish one particular key blank from another. Thus, matching a particular cut key with the corresponding key blank (i.e. identifying a key) may involve matching the cut key with an image of the corresponding key blank and/or matching the cut key with the key blank part number that identifies the corresponding key blank. Consequently, phrases such as “matches with” and “corresponds to” may be used interchangeably throughout the following disclosure.

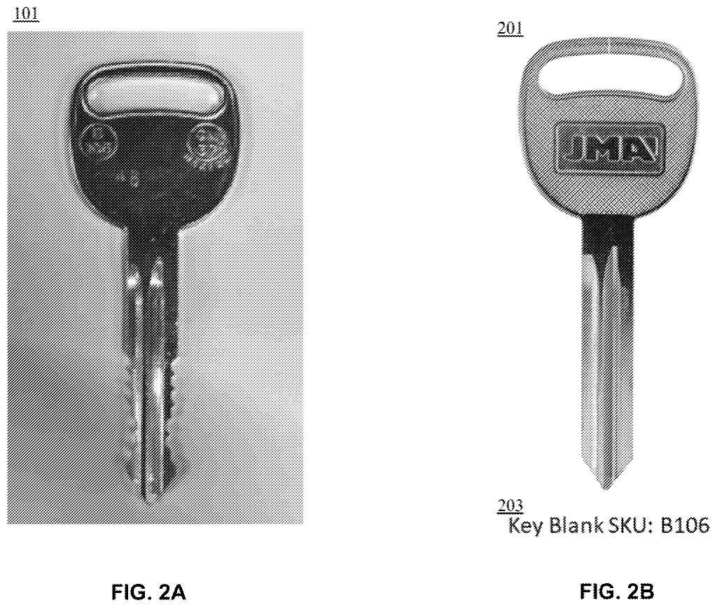

FIG. 2A is an illustrative example of a user cut key 101 that a user may wish to identify, in accordance with one embodiment.

FIG. 2B is an illustrative example of a key blank 201 that corresponds to the user cut key 101 of FIG. 2A, in accordance with one embodiment.

Referring to FIG. 1, FIG. 2A, and FIG. 2B together, in one embodiment, the goal of the method and system disclosed herein is to be able to rapidly identify the key blank and/or key blank part number that matches with a particular cut key. In various embodiments, user cut key 101 is provided to, or otherwise obtained by, user 102, and the method and system disclosed herein is able to match user cut key 101 to the corresponding key blank part number associated with key blank 201, represented here by matched key blank part number 203. While in general, the term “key blank” is used throughout the specification to refer to the actual physical key blank object, and the term “key blank part number” is used to refer to data that identifies the physical key blank object, the two terms may also be used interchangeably. For example, “identifying a key blank” should generally be taken to mean the same thing as “identifying a key blank part number.”

Returning now to FIG. 1, in one embodiment, in order for the method and system disclosed herein to perform the key matching, machine learning training module 138 first trains one or more machine learning models 140 to identify matching key blanks, resulting in one or more trained key blank identification machine learning models.

In order to train the one or more machine learning models 140, in one embodiment, a large number of images of cut keys are aggregated and stored in key image database 124 as initial cut key image data 128. In one embodiment, a large number of images of key blanks are also aggregated and stored in key image database 124 as key blank image data 126. In some embodiments, over 40,000 images of cut keys and key blanks are aggregated and stored in key image database 124. In other embodiments, fewer images may be aggregated, however, utilizing fewer images may result in decreased accuracy of the machine learning models utilized herein.

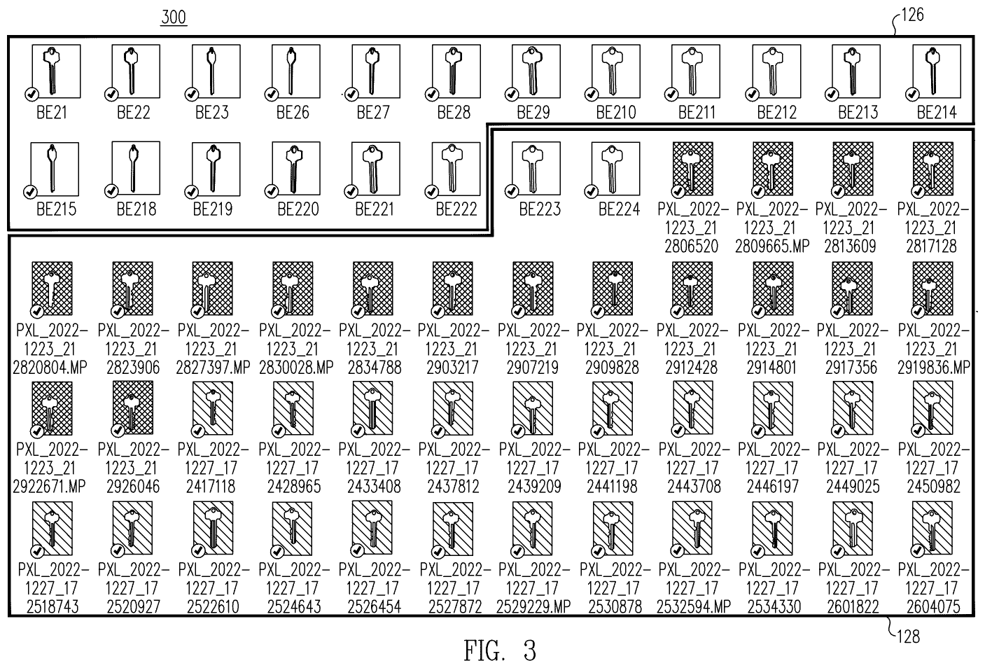

FIG. 3 is an illustrative example 300 of a variety of key images in a key image database in accordance with one embodiment.

As shown in FIG. 3, in one embodiment, for each particular cut key in initial cut key image data 128, a plurality of images for each key are stored, which show the key at varying angles and with different backgrounds and lighting conditions. This allows the machine learning models to achieve greater accuracy in matching cut keys to key blanks, since images provided by a user for identification are not likely to be presented uniformly. Similarly, in one embodiment, for each particular key blank in key blank image data 126, a plurality of images may be provided to show the key blank from different angles.

Returning now to FIG. 1, in one embodiment, initial cut key image annotation module 134 retrieves initial cut key image data 128 and key blank part number data 130 from key image database 124 and annotates at least a portion of the initial cut key images represented by initial cut key image data 128 with the corresponding key blank part number to generate annotated key image data 132.

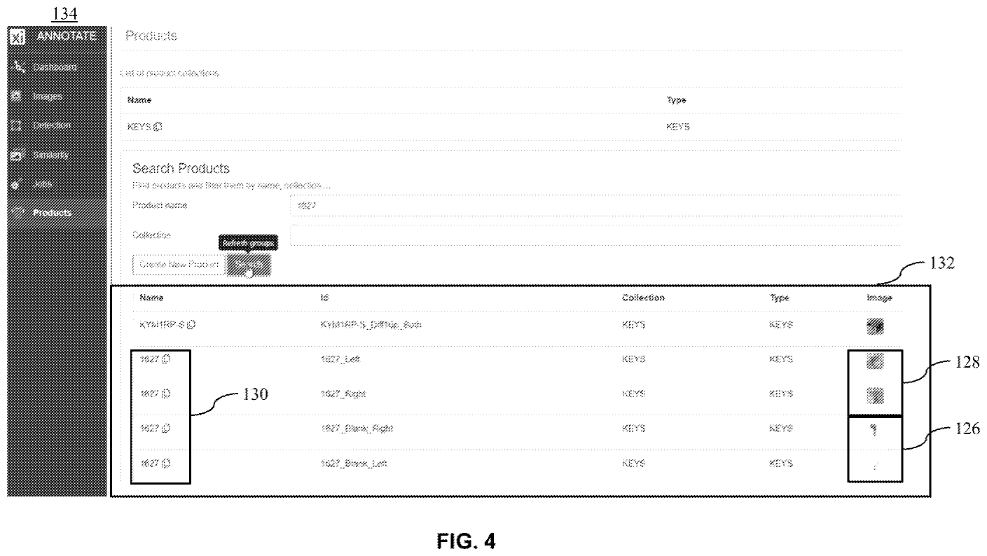

FIG. 4 is an exemplary screenshot of a portion of initial cut key image annotation module 134, in accordance with one embodiment.

Referring to FIG. 1 and FIG. 4 together, in one embodiment, initial cut key image annotation module 134 labels each initial cut key image in initial cut key image data 128 with the corresponding key blank part number, represented here by key blank part number data 130. In one embodiment, each key blank image in key blank image data 126 is also labeled with the corresponding key blank part number, represented here by key blank part number data 130. In one embodiment, the annotated data is then stored in key image database 124 as annotated key image data 132.

Returning now to FIG. 1, in one embodiment, at least part of annotated key image data 132 is formatted for utilizing as training data for one or more machine learning models, resulting in the generation of key blank identification training data 136. In one embodiment, key blank identification training data 136 is then provided to machine learning training module 138.

In one embodiment, machine learning training module 138 utilizes key blank identification training data 136 to train one or more machine learning models 140 to identify key blank part numbers based on user images of cut keys.

In various embodiments, a variety of machine learning models and algorithms known to those of skill in the art may be utilized to generate trained key blank identification machine learning model 142. Identification of key blank part numbers based on user images of cut keys requires detecting visual similarities between images, and so image similarity machine learning models are best suited to this task. Examples of algorithms commonly used for image similarity detection include, but are not limited to, Siamese Neural Networks and Convolutional Neural Networks (CNNs).

In various embodiments, in order to for a machine learning model to be able to effectively identify image similarities, the machine learning model must be trained to distinguish between features of an image that are most important for detecting whether the images are similar and features of an image that are less important for detecting whether the images are similar. In the specific case where the images being compared are images of a singular object, the relative importance of the various object features in detecting similarity depends on the particular object depicted in the images being analyzed. For example, in the disclosed embodiments, the images being analyzed are all images of key objects, and so it becomes important to distinguish between the different parts of a key.

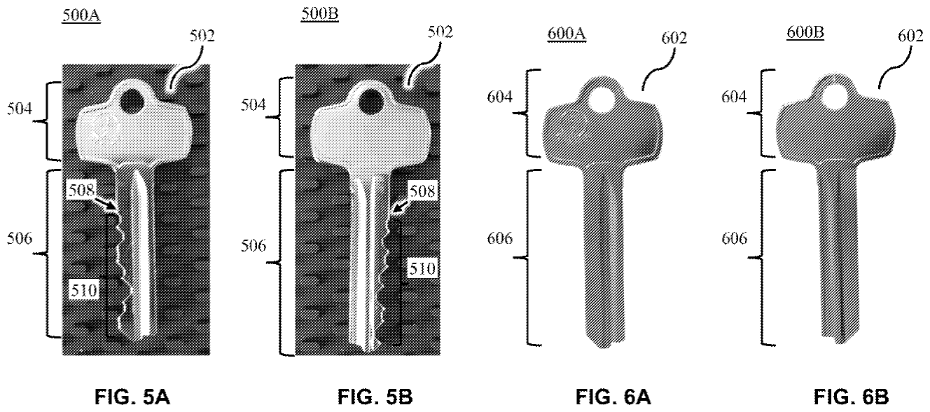

FIG. 5A and FIG. 5B are illustrative examples of the distinct portions of a single-sided cut key 502 in accordance with one embodiment.

Particularly, FIG. 5A shows single-sided cut key first surface image 500A, which is an image of a first surface (sometimes called a front side or a first side) of single-sided cut key 502, while FIG. 5B shows single-sided cut key second surface image 500B, which is an image of a second surface (sometimes called a back side or a second side) of single-sided cut key 502. In general, keys have two main parts, the key head (or top), and the key bottom. These are shown in FIG. 5A and FIG. 5B as single-sided cut key head 504, and single-sided cut key bottom 506. Typically, keys also have a portion of the key bottom referred to as the “shoulder,” which is shown in FIG. 5A and FIG. 5B as single-sided cut key shoulder 508. The portion of the key bottom below the shoulder is typically the portion where the cuts are made in a key. The key cuts are shown in FIG. 5A and FIG. 5B as single-sided key cuts 510. In single-sided cut key first surface image 500A, single-sided key cuts 510 are shown facing to the left, while in single-sided cut key second surface image 500B, single-sided key cuts 510 are shown facing to the right. The importance of these various key parts in determining key similarity will be discussed in additional detail below.

FIG. 6A and FIG. 6B are illustrative examples of the distinct portions of a single-sided key blank 602 in accordance with one embodiment.

FIG. 6A shows single-sided key blank first surface image 600A, which is an image of a first surface of single-sided key blank 602, while FIG. 6B shows single-sided key blank second surface image 600B, which is an image of a second surface of single-sided key blank 602.

Referring to FIGS. 5A, 5B, 6A, and 6B together, in this illustrative embodiment, single-sided key blank 602 is the key blank that corresponds to, or matches with, single-sided cut key 502. In other words, single-sided cut key 502 was produced by making cuts into single-sided key blank 602. Like its cut key counterpart, single-sided key blank 602 also has a key head and a key bottom. These are shown in FIG. 6A and FIG. 6B as single-sided key blank head 604, and single-sided key blank bottom 606. On some key blanks, the shoulder is well-defined, while on other key blanks, such as the one shown in FIG. 6A and FIG. 6B, the shoulder does not become well-defined until after the key has been cut, as will be shown in the additional examples discussed below.

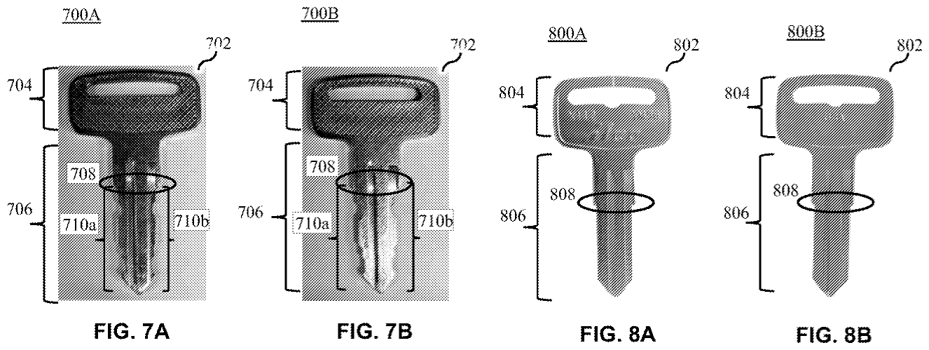

FIG. 7A and FIG. 7B are illustrative examples of the distinct portions of a double-sided cut key 702 in accordance with one embodiment.

FIG. 7A shows double-sided cut key first surface image 700A, which is an image of a first surface of double-sided cut key 702, while FIG. 7B shows double-sided cut key second surface image 700B, which is an image of a second surface of double-sided cut key 702. As with single-sided keys, double-sided keys also have two main parts, the key head (or top), and the key bottom. These are shown in FIG. 7A and FIG. 7B as double-sided cut key head 704, and double-sided cut key bottom 706. The shoulder of double-sided cut key 702 is shown in FIG. 7A and FIG. 7B as double-sided cut key shoulder 708. As noted above, the portion of the key bottom below the shoulder is typically the portion where the cuts are made in a key, and for a double-sided key, the cuts are made on both sides of the key bottom, below each side of the shoulder. The key cuts are shown in FIG. 7A and FIG. 7B as left-facing double-sided key cuts 710a, and right-facing double-sided key cuts 710b. While it is possible for the left-facing cuts on a double-sided key to be different than the right-facing cuts on a double-sided key, typically the left-facing cuts on a double-sided key will mirror the right-facing cuts.

FIG. 8A and FIG. 8B are illustrative examples of the distinct portions of a double-sided key blank 802 in accordance with one embodiment.

FIG. 8A shows double-sided key blank first surface image 800A, which is an image of a first surface of double-sided key blank 802, while FIG. 8B shows double-sided key blank second surface image 800B, which is an image of a second surface of double-sided key blank 802.

Referring to FIGS. 7A, 7B, 8A, and 8B together, in this illustrative embodiment, double-sided key blank 802 is the key blank that corresponds to, or matches with, double-sided cut key 702. In other words, double-sided cut key 702 was produced by making cuts into double-sided key blank 802. Like its cut key counterpart, double-sided key blank 802 also has a key head and a key bottom. These are shown in FIG. 8A and FIG. 8B as double-sided key blank head 804, and double-sided key blank bottom 806. As noted above, on some key blanks, the shoulder is well-defined, while on other key blanks, the shoulder does not become well-defined until after the key has been cut. Double-sided key blank 802 is an example of a key blank with a well-defined shoulder, which is shown here as double-sided key blank shoulder 808.

In training a machine learning model to detect similarities between cut keys and key blanks, certain parts of the key are more important to focus on than others. For example, in various embodiments, if the trained machine learning model were to receive double-sided cut key first surface image 700A and/or double-sided cut key second surface image 700B as input, its primary focus should be on detecting similarities between the portion of double-sided cut key 702 that is below double-sided cut key shoulder 708, and the portion of double-sided key blank 802 that is below double-sided key blank shoulder 808. Particularly, the machine learning model is trained to “look past” or “ignore” the cuts on the cut key (such as left-facing double-sided key cuts 710a, and right-facing double-sided key cuts 710b) to focus on the milling patterns that the keys have in common, in order to identify the closest possible key blank match.

In various embodiments, while the portion of the key below the shoulder is the most important in detecting similarities between cut keys and key blanks, the key head can also sometimes be helpful in identifying a key more rapidly.

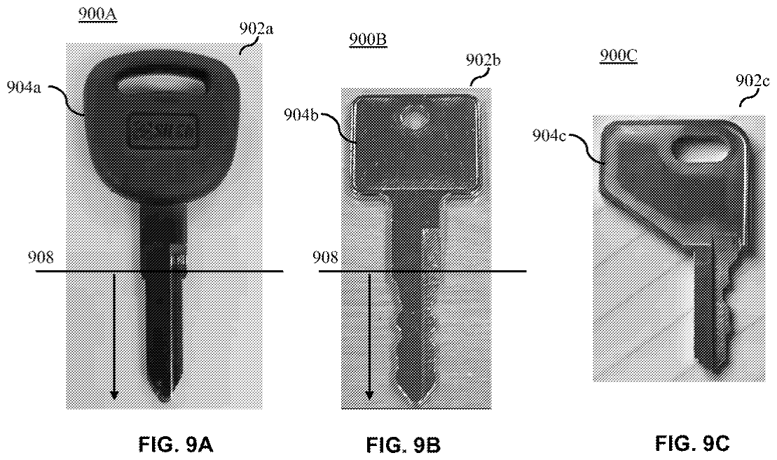

FIG. 9A and FIG. 9B are illustrative examples of a cut key/key blank pair with differently shaped heads, in accordance with one embodiment.

FIG. 9A is a key blank image 900A of key blank 902a. FIG. 9B is a cut key image 900B of a cut key 902b, which is a key that was cut from corresponding key blank 902a. As can be seen in FIG. 9A and FIG. 9B, as one illustrative example, key blank head 904a and cut key head 904b are of different shapes and materials. Key blank head 904a is plastic and has a rounded shape. Cut key head 904b is metal and has a square shape. Further, key blank head 904a is larger than cut key head 904b. Despite the fact that key blank head 904a is not at all similar to cut key head 904b, when ignoring the key cuts, it can be seen that the dimensions and milling patterns that appear below shoulder line 908 of each key are in fact identical. Thus, in this particular illustrative example, analysis of only the key heads of key blank 902a and cut key 902b by the machine learning model would fail to produce accurate results when detecting similarities between cut keys and their key blank counterparts. That said, there are some instances in which analysis of a key head by the machine learning model can be of great assistance in more rapidly and accurately identifying the matching key blank.

FIG. 9C is a key image 900C of a key 902c, which has a key head 904c that is particularly distinctive. While there are many standard shapes for key heads, some key heads are shaped in a manner that is not as common in the industry, which can clearly prove useful in identification of the cut key's matching key blank.

In various embodiments, in order to account for the differences in importance of the individual key parts when detecting similarities between cut keys and their key blank counterparts, weighting parameters are introduced during training of the machine learning models. In one embodiment, a 90% weighting is given to the key bottom and a 10% weighting is given to the key head. In other embodiments, different weightings can be used to further fine-tune the model. In some embodiments, the weighting may be split between more than 2 parts of the key. For example, the weighting may be split between the key head, the portion of the key bottom above the shoulder, and the portion of the key bottom below the shoulder.

Returning now to FIG. 1, in one embodiment, once machine learning models 140 have been trained by machine learning training module 138 using key blank identification training data 136 to generate trained key blank identification machine learning model 142, a user may be provided with a user interface to key blank identification application 105, which allow the user to utilize trained key blank identification machine learning model 142 to identify key blanks that correspond to one or more cut keys.

In some embodiments, key blank identification application 105 is an application that can be utilized on a mobile device associated with user 102. In some embodiments, key blank identification application 105 is an application that can be utilized on a laptop, desktop, or other computing device associated with user 102. In some embodiments, key blank identification application 105 can be provided to user 102 from a machine/device/interface not associated with the user. For example, in some embodiments, key blank identification application 105 may be provided to user 102 via a public terminal or kiosk, which provides the user with the ability to identify the key blank corresponding to a cut key in any number of environments or locations.

In various embodiments, key blank identification application 105 may be any type of application that is capable of receiving image data from a user through a user interface, and displaying data to the user through a user interface, including, but not limited to, a mobile computing system application, a desktop computing system application, an application provided by an Internet of Things (IoT) device, any combination thereof, and/or any other type of computer-based application currently known to those of skill in the art, or any other type of computer-based application that may be developed after the time of filing. In various embodiments, the user interface may include any combination of a graphical user interface, an audio-based user interface, a touch-based user interface, or any other type of user interface currently known to those of skill in the art, or any other type of user interface that may be developed after the time of filing.

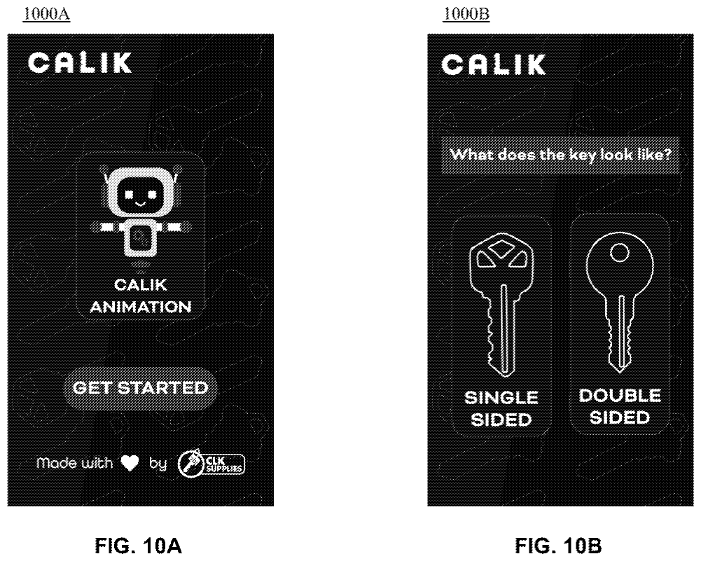

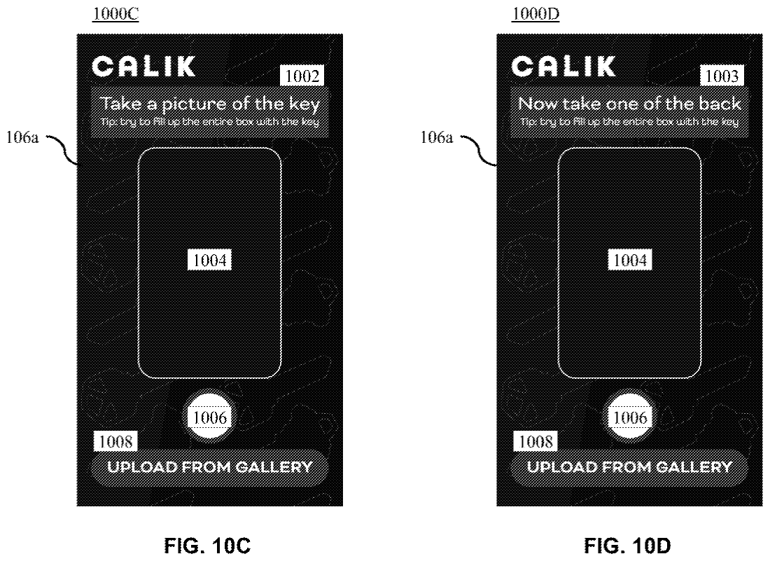

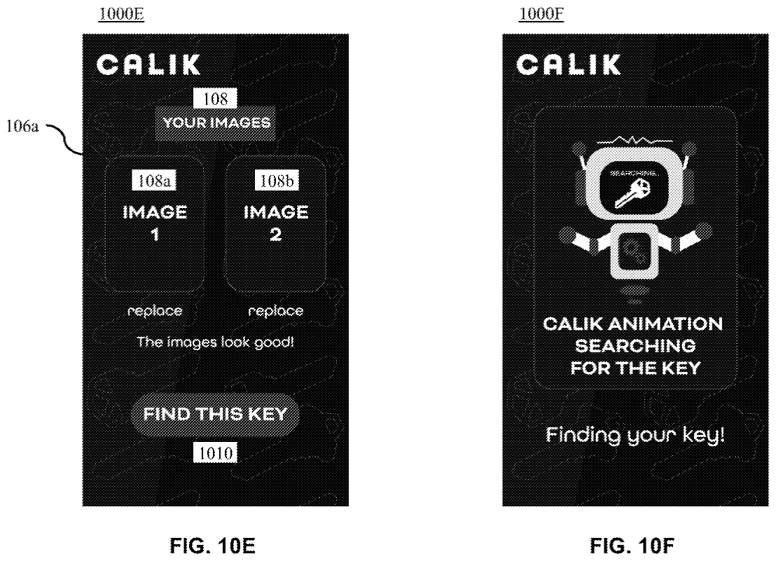

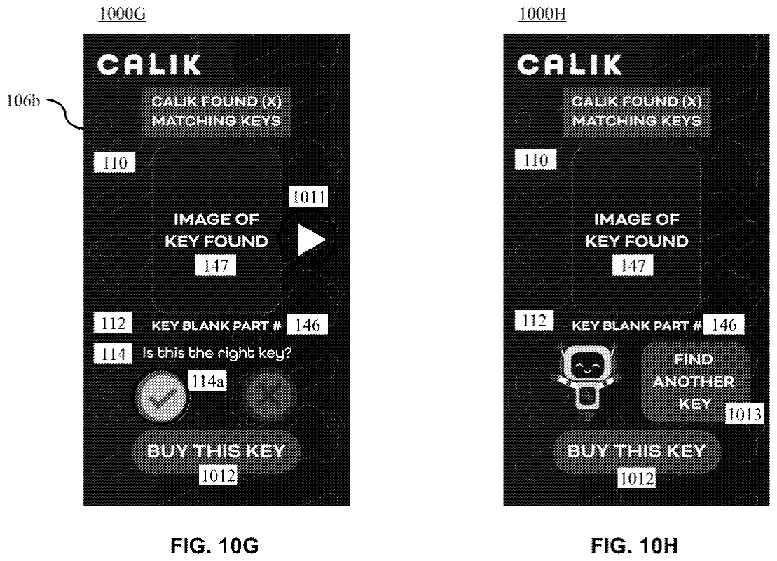

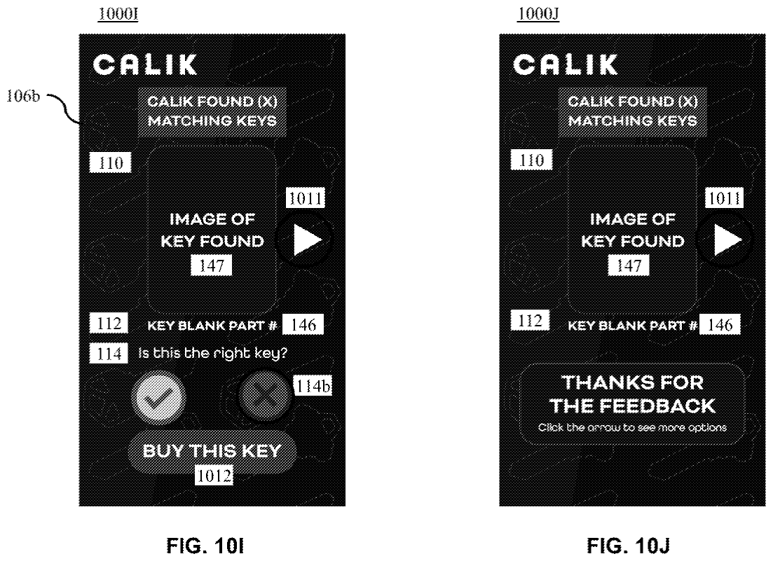

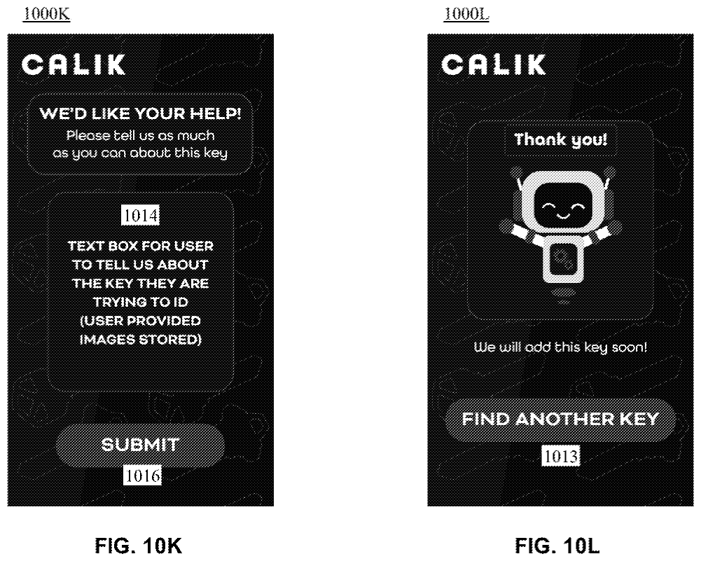

FIG. 10A through FIG. 10L are screenshots of an exemplary user interface for identifying key blank part numbers in accordance with one embodiment.

FIG. 10A is an exemplary screenshot 1000A of a landing page of key blank identification application 105, which may be presented to a user, in accordance with one embodiment.

FIG. 10B is an exemplary screenshot 1000B of a user interface screen for providing key type information, in accordance with one embodiment.

Referring to FIG. 1 and FIG. 10B together, in one embodiment, user 102 may be presented with a user interface screen for providing key blank identification application 105 with information related to the type of key that user 102 wishes to identify. For example, user cut key 101 may be a single-sided key or a double-sided key. In one embodiment, collecting this information may be useful in situations where key blank identification application 105 processes identification of single-sided keys in a manner that is different than the processing of double-sided keys. In some embodiments however, user 102 is not prompted to provide information as to whether user cut key 101 is a single-sided or double-sided key, because key blank identification application 105 may process both types of keys in an identical manner.

FIG. 10C and FIG. 10D are exemplary screenshots 1000C and 1000D of user interface screens for obtaining images of user cut key 101 from user 102, in accordance with one embodiment.

Referring to FIG. 1, FIG. 10C, and FIG. 10D together, as noted above, in one embodiment, key blank identification application 105 includes one or more user interface screens 106.

As shown in FIG. 1, in one embodiment, user interface screens 106 include one or more user input screens 106a. Exemplary screenshot 1000C of FIG. 10C shows a first one of user input screens 106a. In one embodiment, the first one of user input screens 106a provides user 102 with first user input prompt 1002, which asks user 102 to take a picture of a first surface of user cut key 101. In one embodiment, sizing box 1004 is presented to user 102 and user 102 is asked to take the picture of the first surface of user cut key 101 such that user cut key 101 fills as much area of sizing box 1004 as possible. The purpose of this request is to ensure that the images of user cut key 101 that will be uploaded to key blank identification application environment 122 for identification are comparable in size to the images stored in key image database 124, which helps to ensure accuracy of the results that will be output to user 102.

In one embodiment, once user 102 has positioned the camera view of the first surface of user cut key 101 accordingly, user 102 may take the picture of the first surface of user cut key 101 using image capture button 1006. In some embodiments, particularly if the user computing environment 104 does not have camera capabilities, rather than taking a new photo of the first surface of user cut key 101, user 102 may instead choose to select upload image button 1008 to upload an already existing photo of the first surface of user cut key 101 from a photo gallery or other data storage area associated with user 102.

Similarly, exemplary screenshot 1000D shows a second one of user input screens 106a, in accordance with one embodiment. In one embodiment, the second one of user input screens 106a provides user 102 with second user input prompt 1003, which asks user 102 to take a picture of a second surface of user cut key 101. Again, user 102 is provided with sizing box 1004, image capture button 1006 and upload image button 1008 to assist with providing an image of the second surface of user cut key 101.

It should be noted that, while an image of a first surface of a double-sided cut key may be essentially identical to an image of a second surface of a double-sided cut key (in the typical situation where the cuts on both sides of the double-sided key mirror each other), in some embodiments it is still beneficial to request an image of both sides from the user (e.g., to simplify/streamline the user interface and/or to provide additional image data points for analysis).

FIG. 10E is an exemplary screenshot 1000E of a user interface screen, which presents user 102 with the provided images side-by-side for approval, in accordance with one embodiment.

Referring to FIG. 1 and FIG. 10E together, as shown in FIG. 1, in one embodiment, user cut key images 108 include cut key first surface image 108a and cut key second surface image 108b, as provided by the user on the previous user input screens 106a. In one embodiment, user 102 is given the option to replace one or both of the provided cut key images 108, should user 102 not be satisfied with the images. Once user 102 is satisfied with the provided cut key images 108, user 102 may proceed to initiate the key search using find key button 1010.

FIG. 10F is an exemplary screenshot 1000F of a screen that may be shown to a user while key blank identification application 105 is searching for the matching key blank, in accordance with one embodiment.

Returning now to FIG. 1, in one embodiment, once user 102 has initiated the key search using user input screens 106a, user cut key images 108 are uploaded to key blank identification application environment 122 over the one or more communications networks 154, and user cut key images 108 are acquired by user interface image acquisition module 144. In one embodiment, once user cut key images 108 are acquired by user interface image acquisition module 144, user cut key images 108 are provided to trained key blank identification machine learning model 142 for identification.

As discussed above, with respect to the training of machine learning models 140, in various embodiments, trained key blank identification machine learning model 142 is able to output one or more potential key blank matches for user cut key 101 based on a similarity analysis of user cut key images 108, initial cut key image data 128, and key blank image data 126, where the trained key blank identification machine learning model 142 weights features of the key bottom more highly than features of the key head. In one embodiment, the potential matches are ranked from most likely match to least likely match. Typically, trained key blank identification machine learning model 142 will discover between 5 and 10 potential matches, however in some embodiments, fewer than 5 or more than 10 potential matches may be identified.

In one embodiment, once the potential matches have been identified and ranked, the part numbers and rankings associated with each of the potential matches are aggregated to generate matched key blank part number data 146.

In one embodiment, matched key blank part number data 146 is provided to user interface data display module 148, which retrieves, from key image database 124, matched key blank image data 147, which contains the key blank images corresponding to each of the matched key blank part numbers of matched key blank part number data 146. In one embodiment, user interface data display module 148 then provides matched key blank part number data 146 and matched key blank image data 147 to one or more results output screens 106b of user interface screens 106.

As noted above, in one embodiment, results output screen 106b includes key blank image display 110, key blank part number display 112, and user feedback options 114. In one embodiment, key blank image display 110 of results output screen 106b displays matched key blank image data 147. In one embodiment, key blank part number display 112 displays matched key blank part number data 146. In one embodiment, user feedback options 114 includes affirmative feedback button 114a and negative feedback button 114b. In some embodiments, user feedback options 114 are not included on results output screen 106b and other mechanisms for obtaining user feedback are employed.

FIG. 10G is an exemplary screenshot 1000G of a results output screen 106b, in accordance with one embodiment.

Referring to FIG. 1 and FIG. 10G together, as noted above, in one embodiment, matched key blank part number data 146 includes ranking data, which indicates which of the potential key blank part number matches are most likely to be the correct match. As one illustrative example, if ten potential matches were found, the most likely match of the potential matches would be match #1, and the least likely match of the potential matches would be match #10. In other embodiments, other ranking systems may be utilized to rank the potential matches.

In one embodiment, key blank image display 110 initially displays the image of the key blank that corresponds with match #1 from matched key blank image data 147, and key blank part number display 112 initially displays the key blank part number that corresponds with match #1 from matched key blank part number data 146. In various embodiments, user 102 is also presented with next match button 1011, which enables the user to view the images and part numbers of the other potential matches. In one embodiment, user 102 is also presented with buy button 1012, which enables user 102 to purchase one or more of the key blanks corresponding to the potential match that they are currently viewing.

In one embodiment, user 102 is also presented with user feedback options 114 to allow the user to inform key blank identification application 105 as to whether a potential match is a correct match. In various embodiments, user 102 can provide feedback for one, several, all, or none of the potential matches.

In one embodiment, upon selection of affirmative feedback button 114a, user interface feedback acquisition module 150 obtains the key blank part number that user 102 indicated as being a correct match, and also collects the user cut key images 108 that were provided to key blank identification application 105 by user 102. The correct key blank part number and the user cut key images 108 are then passed to user cut key image annotation module 152.

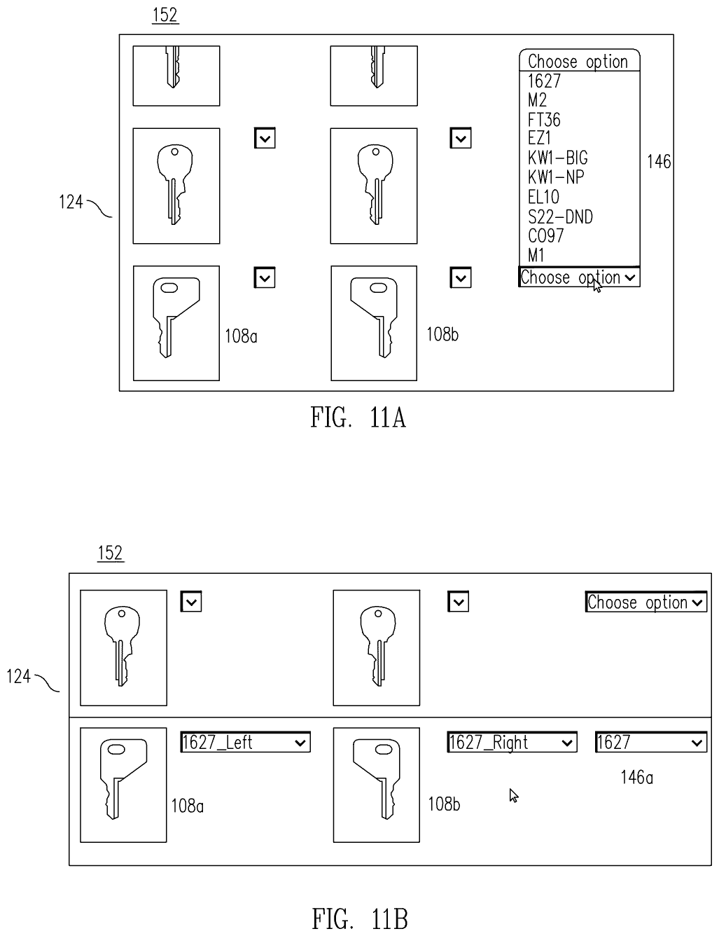

FIG. 11A and FIG. 11B are illustrative examples of portions of a module for annotating cut key images, such as user cut key image annotation module 152, in accordance with one embodiment.

Referring to FIG. 1, FIG. 11A, and FIG. 11B together, in one embodiment, user cut key images 108, including cut key first surface image 108a and cut key second surface image 108b are stored in a portion of key image database 124, as shown in FIG. 11A. In one embodiment, for each pair of cut key images in key image database 124, an interface on the backend of key blank identification application 105 allows for manual selection and/or automatic assignment of the correct key blank part number from a listing of the matched key blank part numbers in matched key blank part number data 146. As shown in FIG. 11B, in one embodiment, upon selection/assignment of the correct key blank part number 146a, cut key first surface image 108a (left-facing cuts) and cut key second surface image 108b (right-facing cuts) are annotated with the correct key blank part number 146a. In one embodiment, the user cut key images 108 and their corresponding correct key blank part number 146a are stored in key image database 124 as annotated key image data 132.

In various embodiments, annotating the user cut key images 108 and storing the newly annotated images in key image database 124 allows the trained key blank identification machine learning model 142 to become more intelligent over time. For example, the newly generated annotated key image data 132 can then be incorporated into key blank identification training data 136 for further refinement of the machine learning models. As one illustrative example, if match #1 of matched key blank part number data 146 is determined to be an incorrect match, or if trained key blank identification machine learning model 142 cannot find any matches, then key image database 124 can be updated to incorporate the new user cut key images 108 with the correct annotation.

FIG. 10H is an exemplary screenshot 1000H of a user interface screen that may be displayed to user 102 upon user 102 confirming that one of the potential matches is a correct match, in accordance with one embodiment.

Referring to FIG. 1 and FIG. 10H together, in one embodiment, once user 102 has confirmed that one of the potential matches is a correct match and key image database 124 has been updated with the newly annotated cut key image data 132, user 102 may be presented with an additional screen, which may allow user 102 to identify the key blank for an additional cut key, using find another key button 1013, or to purchase one or more of the key blanks corresponding to the correctly matched key blank part number using buy button 1012.

FIG. 10I is an exemplary screenshot 1000I of a results output screen 106b, in accordance with one embodiment.

Referring to FIG. 1, FIG. 10G, and FIG. 10I together, in one embodiment, FIG. 10I is largely the same as FIG. 10G, with the exception that it shows a user indicating that the displayed key is not a match. As with FIG. 10G, in one embodiment, key blank image display 110 initially displays the image of the key blank that corresponds with match #1 from matched key blank image data 147, and key blank part number display 112 initially displays the key blank part number that corresponds with match #1 from matched key blank part number data 146. In various embodiments, user 102 is also presented with next match button 1011, which enables the user to view the images and part numbers of the other potential matches.

In one embodiment, user 102 is also presented with buy button 1012, which enables user 102 to purchase one or more of the key blanks corresponding to the potential match that they are currently viewing. In some embodiments, the user will already be in possession of the correct key blank and being provided with the correct key blank part number allows the user to locate and obtain the key blank from a physical storage location. In various embodiments, once the user is possession of the correct physical key blank, the user is able to cut the key blank to duplicate the original cut key.

As with FIG. 10G, in one embodiment, user 102 is also presented with user feedback options 114 to allow the user to inform key blank identification application 105 as to whether a potential match is a correct match. In various embodiments, user 102 can provide feedback for one, several, all, or none of the potential matches.

In one embodiment, upon selection of negative feedback button 114b, user interface feedback acquisition module 150 obtains the key blank part number that user 102 indicated as being an incorrect match, and also collects the user cut key images 108 that were provided to key blank identification application 105 by user 102. The incorrect key blank part number and the user cut key images 108 are then passed to user cut key image annotation module 152, which may update key image database 124 with an indication that the incorrect key blank part number should not be provided as a match for future images that are similar to user cut key images 108.

FIG. 10J is an exemplary screenshot 1000J of a user interface screen that may be displayed to user 102 upon user 102 confirming that one of the potential matches is an incorrect match, in accordance with one embodiment.

Referring to FIG. 1 and FIG. 10J together, in one embodiment, once user 102 has confirmed that one of the potential matches is an incorrect match and key image database 124 has been updated with this feedback, user 102 may be presented with an additional screen, which thanks the user for the feedback, and prompts the user to utilize next match button 1011 to view additional matches of matched key blank part number data 146.

FIG. 10K is an exemplary screenshot 1000K of a user interface screen for soliciting text feedback from user 102, in accordance with one embodiment.

Referring to FIG. 1 and FIG. 10K together, in one embodiment, in the event that trained key blank identification machine learning model 142 did not find any matches for user cut key images 108, feedback text box 1014 is provided to user 102 to allow user 102 to provide additional information about the key that they are trying to identify. In one embodiment, upon selection of submit button 1016, the user text feedback is provided to user interface feedback acquisition module 150 for further processing.

FIG. 10L is an exemplary screenshot 1000L of a user interface screen for acknowledging the text feedback provided by user 102, in accordance with one embodiment.

Referring to FIG. 1 and FIG. 10L together, in one embodiment, upon acknowledgement of the text feedback provided by user 102, user 102 is presented with find another key button 1013, which brings the user back to user input screens 106a for uploading images of another key.

### Process

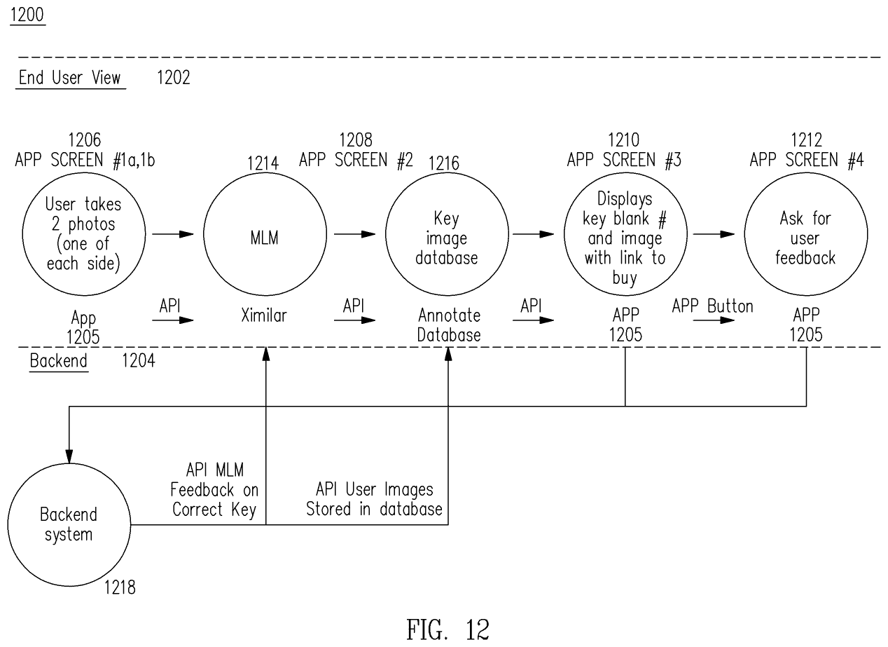

FIG. 12 is a simplified end user/backend flow diagram 1200 of a process for identifying key blank part numbers using machine learning models, in accordance with one embodiment.

In various embodiments, a method for identifying key blank part numbers using machine learning models includes end user view operations 1202 and backend operations 1204.

In one embodiment, an end user is provided with a user interface to key blank identification application 1205. In one embodiment, the user interface of key blank identification application 1205 includes one or more first application screens 1206, one or more second application screens 1208, one or more third application screens 1210, and one or more fourth application screens 1212.

In one embodiment, end user view operations 1202 includes presenting the user, through the user interface of key blank identification application 1205, with one or more first application screens 1206, which allow the user to upload two images of the cut key that the user would like to identify. Illustrative examples of the one or more first application screens 1206 are shown in FIGS. 10C, 10D, and 10E, discussed in detail above.

In one embodiment, once the cut key images are uploaded by the user using the one or more first application screens 1206, end user view operations 1202 further includes providing the uploaded cut key images to a machine learning model (MLM), such as trained key blank identification machine learning model 1214.

In one embodiment, once trained key blank identification machine learning model 1214 has received the uploaded cut key images, end user view operations 1202 further includes utilizing trained key blank identification machine learning model 1214 to search an image database, such as key image database 1216, for visually similar key images in order to identify one or more key blank part numbers that match the key shown in the uploaded cut key images. In one embodiment, end user view operations 1202 further includes presenting the user with one or more second application screens 1208 while the search is being performed. One illustrative example of a second application screen 1208 that may be presented to the user is shown in FIG. 10F, discussed above.

In one embodiment, once trained key blank identification machine learning model 1214 has identified one or more key blank part numbers that match the key shown in the uploaded cut key images, end user view operations 1202 further includes presenting the user with one or more third application screens 1210. In one embodiment the one or more third application screens 1210 display to the user the one or more matching key blank part numbers, along with the corresponding key blank images. In one embodiment, the one or more third application screens 1210 also provide the user with a link to purchase one or more of the matching key blanks. Illustrative examples of one or more third application screens 1210 that may be presented to the user are shown in FIG. 10G through FIG. 10J, discussed in detail above.

In one embodiment, once the one or more matching key blank part numbers, along with the corresponding key blank images, are displayed to the user, end user view operations 1202 further includes presenting the user with one or more fourth application screens 1212. In one embodiment the one or more fourth application screens 1212 present the user with one or more mechanisms for providing feedback regarding which of the identified matching key blanks (if any) were the correct key blank. Illustrative examples of affirmative/negative feedback solicitation are shown in FIG. 10G through FIG. 10J, discussed above. An illustrative example of text feedback solicitation is shown in FIG. 10K, discussed above.

In one embodiment, once the user provides feedback through the one or more fourth application screens 1212, the user feedback is provided to backend system 1218 for processing. In one embodiment, backend operations 1204 include providing the user feedback to trained key blank identification machine learning model 1214, to enable refinement of trained key blank identification machine learning model 1214. In one embodiment, backend operations 1204 further include annotating the uploaded cut key images with the correct key blank numbers and storing the annotated images in key image database 1216.

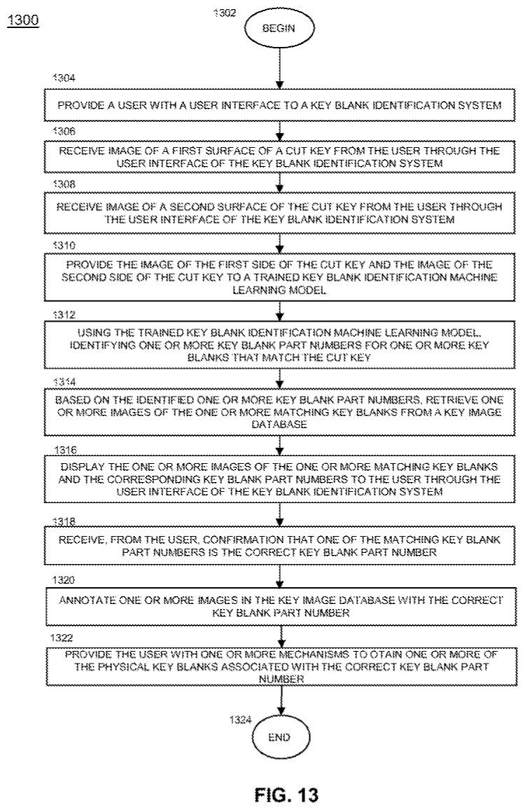

FIG. 13 is a flow chart of a method for identification of key blank part numbers using machine learning models in accordance with one embodiment.

As seen in FIG. 13, process 1300 begins at BEGIN operation 1302 and then process proceeds to operation 1304.

In one embodiment, at operation 1304, a user is provided with a user interface to a key blank identification system.

In some embodiments, the key blank identification system includes an application that can be utilized on a mobile device associated with the user. In some embodiments, the key blank identification system includes an application that can be utilized on a laptop, desktop, or other computing device associated with the user. In some embodiments, the key blank identification system can be provided to the user from a machine/device/interface not associated with the user. For example, in some embodiments, the key blank identification system may be provided to the user via a public terminal or kiosk, which provides the user with the ability to identify the key blank corresponding to a cut key in any number of environments or locations.

In various embodiments, the key blank identification system may include any type of computer application that is capable of receiving image data from a user through a user interface, and displaying data to the user through a user interface, including, but not limited to, a mobile computing system application, a desktop computing system application, an application provided by an Internet of Things (IoT) device, any combination thereof, and/or any other type of computer-based application currently known to those of skill in the art, or any other type of computer-based application that may be developed after the time of filing. In various embodiments, the user interface may include any combination of a graphical user interface, an audio-based user interface, a touch-based user interface, or any other type of user interface currently known to those of skill in the art, or any other type of user interface that may be developed after the time of filing.

In one embodiment, once the user is provided with the user interface at operation 1304, process flow proceeds to operation 1306.

In one embodiment, at operation 1306, an image of a first surface of a cut key is received from the user through the user interface of the key blank identification system.

As discussed above, in one embodiment, a first user input screen provides the user with a first user input prompt, which asks the user to take a picture of a first surface of a user cut key. In one embodiment, a sizing box is presented to the user and the user is asked to take the picture of the first surface of the user cut key such that the user cut key fills as much area of the sizing box as possible. In one embodiment, once the user has positioned the camera view of the first surface of the user cut key accordingly, the user may take the picture of the first surface of the user cut key using an image capture button. In some embodiments, rather than taking a new photo of the first surface of the user cut key, the user may instead choose to upload an already existing photo of the first surface of the user cut key from a photo gallery or other data storage area associated with the user.

In one embodiment, once the image of the first surface of the cut key is received at operation 1306, process flow proceeds to operation 1308.

In one embodiment, at operation 1308, an image of a second side of a cut key is received from the user through the user interface of the key blank identification system.

In one embodiment, a second user input screen provides the user with a second user input prompt, which asks the user to take a picture of a second surface of the user cut key. Again, the user is provided with a sizing box, an image capture button and an upload image button to assist the user with providing an image of the second surface of the user cut key.

In one embodiment, once the image of the second side of the cut key is received at operation 1308, process flow proceeds to operation 1310.

In one embodiment, at operation 1310, the image of the first side of the cut key and the image of the second side of the cut key are provided to a trained key blank identification machine learning model.

In one embodiment, once the images are provided to the trained key blank identification machine learning model at operation 1310, process flow proceeds to operation 1312.

In one embodiment, at operation 1312, the trained key blank identification machine learning model is used to identify one or more key blank part numbers for one or more key blanks that match the cut key.

As discussed above, with respect to the training of the machine learning models, in various embodiments, the trained key blank identification machine learning model is able to output one or more potential key blank matches for a user cut key based on a similarity analysis of user cut key images, initial cut key image data, and key blank image data. In some embodiments, the trained key blank identification machine learning model weights features of the key bottom more highly than features of the key head. In one embodiment, the potential matches are ranked from most likely match to least likely match. In one embodiment, once the potential matches have been identified and ranked, the part numbers and rankings associated with each of the potential matches are aggregated to generate matched key blank part number data.

In one embodiment, once one or more key blank part numbers are identified at operation 1312, process flow proceeds to operation 1314.

In one embodiment, at operation 1314, one or more images of the one or more matching key blanks are retrieved from a key image database based on the identified one or more key blank part numbers.

As discussed above, in one embodiment, the matched key blank part number data is provided to a user interface data display module, which retrieves matched key blank image data from a key image database, wherein the matched key blank image data contains the key blank images corresponding to each of the matched key blank part numbers.

In one embodiment, once one or more images of the one or more matching key blanks are retrieved at operation 1314, process flow proceeds to operation 1316.

In one embodiment, at operation 1316, the one or more images of the one or more matching key blanks and the corresponding key blank part numbers are displayed to the user through the user interface of the key blank identification system.

In one embodiment, the matched key blank part number data and the matched key blank image data are provided to one or more results output screens of the user interface. As noted above, in one embodiment, a results output screen includes a key blank image display, and a key blank part number display. In one embodiment, the key blank image display displays the matched key blank image data. In one embodiment, the key blank part number display displays the matched key blank part number data.

In one embodiment, the matched key blank part number data includes ranking data, which indicates which of the potential key blank part number matches are most likely to be the correct match. In one embodiment, the key blank image display initially displays the image of the key blank that corresponds with the matched key blank image that has the highest ranking, and the key blank part number display initially displays the key blank part number that corresponds with the matched key blank part number that has the highest ranking. In various embodiments, the user is also presented with a next match button, which enables the user to view the images and part numbers of the other potential matches.

In one embodiment, once the one or more images of the one or more matching key blanks and the corresponding key blank part numbers are displayed to the user at operation 1316, process flow proceeds to operation 1318.

In one embodiment, at operation 1318, confirmation that one of the matching key blank part numbers is the correct key blank part number is received from the user.

As noted above, in one embodiment, the results output screen includes user feedback options, which allow the user to inform the key blank identification application as to whether a potential match is a correct match. In various embodiments, the user can provide feedback for one, several, all, or none of the potential matches.

In one embodiment, once confirmation that one of the matching key blank part numbers is the correct key blank part number is received at operation 1318, process flow proceeds to operation 1320.

In one embodiment, at operation 1320, one or more images in the key image database are annotated with the correct key blank part number.

In one embodiment, upon confirmation that one of the matching key blank part numbers is the correct key blank part number, a user interface feedback acquisition module obtains the correct key blank part number, and also collects the user cut key images that were provided to the key blank identification system by the user. The correct key blank part number and the user cut key images are then passed to an image annotation module.

In one embodiment, the user cut key images, including the cut key first surface image and the cut key second surface image are stored in a portion of a key image database. In one embodiment, for each pair of cut key images in the key image database, an interface on the backend of key blank identification application allows for manual selection and/or automatic assignment of the correct key blank part number from a listing of the matched key blank part numbers in the matched key blank part number data. In one embodiment, upon selection/assignment of the correct key blank part number, the cut key first surface image and the cut key second surface image are annotated with the correct key blank part number. In one embodiment, the user cut key images and their corresponding correct key blank part number are stored in the key image database as annotated key image data.

In various embodiments, annotating the user cut key images and storing the newly annotated images in the key image database allows the trained key blank identification machine learning model to become more intelligent over time. For example, the newly generated annotated key image data can then be incorporated into the key blank identification training data for further refinement of the machine learning models.

In one embodiment, once one or more images in the key image database are annotated with the correct key blank part number at operation 1320, process flow proceeds to operation 1322.

In one embodiment, at operation 1322, the user is provided with one or more mechanisms to obtain one or more of the physical key blanks associated with the correct key blank part number.

In some embodiments, the user will already be in possession of the correct key blank and being provided with the correct key blank part number allows the user to locate and obtain the key blank from a physical storage location. In one embodiment, the results output screen presents the user with a link that enables the user to purchase one or more of the key blanks corresponding identified by the correct key blank part number. In various embodiments, once the user is possession of the correct physical key blank, the user is able to cut the key blank to duplicate the original cut key.

In one embodiment, once the user is provided with one or more mechanisms to obtain one or more of the physical key blanks at operation 1322, process flow proceeds to END operation 1324 where process 1300 is exited to await new data.

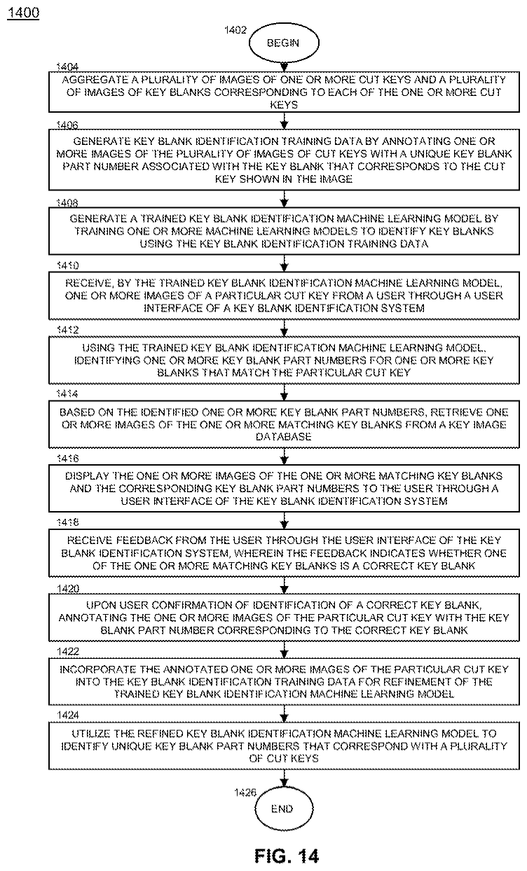

FIG. 14 is a flow chart of a method for training machine learning models and utilizing the trained machine learning models for identification of key blank part numbers in accordance with one embodiment.

As seen in FIG. 14, process 1400 begins at BEGIN operation 1402 and then process proceeds to operation 1404.

In one embodiment, at operation 1404, a plurality of images of one or more cut keys and a plurality of images of key blanks corresponding to each of the one or more cut keys are aggregated.

As discussed above, in one embodiment, a large number of images of cut keys are aggregated and stored in a key image database. In one embodiment, a large number of images of key blanks are also aggregated and stored in the key image database. In some embodiments, over 40,000 images of cut keys and key blanks are aggregated and stored in the key image database. In other embodiments, fewer images may be aggregated, however, utilizing fewer images may result in decreased accuracy of the machine learning models utilized herein.

In one embodiment, for each particular cut key, a plurality of images for each key are stored, which show the key at varying angles and with different backgrounds and lighting conditions. This allows the machine learning models to achieve greater accuracy in matching cut keys to key blanks, since images provided by a user for identification are not likely to be uniform. Similarly, in one embodiment, for each particular key blank, a plurality of images may be provided to show the key blank from different angles.

In one embodiment, once a plurality of images of one or more cut keys and one or more key blanks is aggregated at operation 1404, process flow proceeds to operation 1406.

In one embodiment, at operation 1406, key blank identification training data is generated by annotating one or more images of the plurality of images of cut keys with a unique key blank part number associated with the key blank that corresponds to the cut key shown in the image.

In one embodiment, a cut key image annotation module retrieves initial cut key image data and key blank part number data from the key image database and annotates at least a portion of the initial cut key images represented by the initial cut key image data with a corresponding key blank part number to generate annotated key image data. In one embodiment, the cut key image annotation module labels each initial cut key image with the corresponding key blank part number. In one embodiment, each key blank image is also labeled with the corresponding key blank part number. In one embodiment, the annotated data is then stored in the key image database as annotated key image data.

In one embodiment, at least part of the annotated key image data is formatted for utilizing as training data for one or more machine learning models, resulting in the generation of key blank identification training data.

In one embodiment, once the key blank identification training data is generated at operation 1406, process flow proceeds to operation 1408.

In one embodiment, at operation 1408, a trained key blank identification machine learning model is generated by training one or more machine learning models to identify key blanks using the key blank identification training data.

In one embodiment, the key blank identification training data is provided to a machine learning training module. In one embodiment, the machine learning training module utilizes the key blank identification training data to train one or more machine learning models to identify key blank part numbers based on user images of cut keys. In various embodiments, a variety of machine learning models and algorithms known to those of skill in the art may be utilized to generate a trained key blank identification machine learning model. As discussed above, identification of key blank part numbers based on user images of cut keys requires detecting visual similarities between images, and so image similarity machine learning models are best suited to this task. Examples of algorithms commonly used for image similarity detection include, but are not limited to, Siamese Neural Networks and Convolutional Neural Networks (CNNs).

In various embodiments, in order to for a machine learning model to be able to effectively identify image similarities, the machine learning model must be trained to distinguish between features of an image that are most important for detecting whether the images are similar and features of an image that are less important for detecting whether the images are similar. In the specific case where the images being compared are images of a singular object, the relative importance of the various object features in detecting similarity depends on the particular object depicted in the images being analyzed. For example, in the disclosed embodiments, the images being analyzed are all images of key objects, and so it becomes important to distinguish between the different parts of a key.

In various embodiments, in order to account for the differences in importance of the individual key parts when detecting similarities between cut keys and their key blank counterparts, weighting parameters are introduced during training of the machine learning models. In one embodiment, a 90% weighting is given to the key bottom and a 10% weighting is given to the key head. In other embodiments, different weightings can be used to further fine-tune the model. In some embodiments, the weighting may be split between more than 2 parts of the key. For example, the weighting may be split between the key head, the portion of the key bottom above the shoulder, and the portion of the key bottom below the shoulder.

In one embodiment, once one or more trained machine learning models are generated at operation 1408, process flow proceeds to operation 1410.

In one embodiment, at operation 1410, one or more images of a particular cut key are received, by the trained key blank identification machine learning model, from a user through a user interface of a key blank identification system.

As noted above, in various embodiments, a key blank identification system may include any type of computer application that is capable of accepting image data from a user through a user interface and displaying data to the user through a user interface for the purpose of identifying a key blank part number that corresponds with a cut key. As discussed above, in one embodiment, a user input screen of a key blank identification system user interface provides the user with one or more user input prompts, which ask the user to upload one or more pictures of the particular cut key that they wish to identify. In one embodiment, once the user has uploaded the cut key images, the cut key images are provided to the trained key blank identification machine learning model.

In one embodiment, once one or more images of a particular cut key are received from a user at operation 1410, process flow proceeds to operation 1412.

In one embodiment, at operation 1412, the trained key blank identification machine learning model is used to identify one or more key blank part numbers for one or more key blanks that match the particular cut key

As discussed above, with respect to the training of the machine learning models, in various embodiments, the trained key blank identification machine learning model is able to output one or more potential key blank matches for a user cut key based on a similarity analysis of user cut key images, initial cut key image data, and key blank image data. In some embodiments, the trained key blank identification machine learning model weights features of the key bottom more highly than features of the key head. In one embodiment, the potential matches are ranked from most likely match to least likely match. In one embodiment, once the potential matches have been identified and ranked, the part numbers and rankings associated with each of the potential matches are aggregated to generate matched key blank part number data.

In one embodiment, once one or more key blank part numbers are identified at operation 1412, process flow proceeds to operation 1414.

In one embodiment, at operation 1414, one or more images of the one or more matching key blanks are retrieved from a key image database based on the identified one or more key blank part numbers.

As discussed above, in one embodiment, the matched key blank part number data is provided to a user interface data display module, which retrieves matched key blank image data from a key image database, wherein the matched key blank image data contains the key blank images corresponding to each of the matched key blank part numbers.

In one embodiment, once one or more images of the one or more matching key blanks are retrieved at operation 1414, process flow proceeds to operation 1416.

In one embodiment, at operation 1416, the one or more images of the one or more matching key blanks and the corresponding key blank part numbers are displayed to the user through the user interface of the key blank identification system.

In one embodiment, the matched key blank part number data and the matched key blank image data are provided to one or more results output screens of the key blank identification system user interface. As noted above, in one embodiment, a results output screen includes a key blank image display, and a key blank part number display. In one embodiment, the key blank image display of the results output screen displays the matched key blank image data. In one embodiment, the key blank part number display displays the matched key blank part number data.

In one embodiment, the matched key blank part number data includes ranking data, which indicates which of the potential key blank part number matches are most likely to be the correct match. In one embodiment, the key blank image display initially displays the image of the key blank that corresponds with the matched key blank image that has the highest ranking, and the key blank part number display initially displays the key blank part number that corresponds with the matched key blank part number that has the highest ranking. In various embodiments, the user is also presented with a next match button, which enables the user to view the images and part numbers of the other potential matches.

In one embodiment, once the one or more images of the one or more matching key blanks and the corresponding key blank part numbers are displayed to the user at operation 1416, process flow proceeds to operation 1418.

In one embodiment, at operation 1418, feedback is received from the user through the user interface of the key blank identification system, wherein the feedback indicates whether one of the one or more matching key blanks is a correct key blank.

As noted above, in one embodiment, the results output screen includes user feedback options, which allow the user to inform the key blank identification system as to whether a potential match is a correct match. In various embodiments, the user can provide feedback for one, several, all, or none of the potential matches.

In one embodiment, once feedback is received from the user at operation 1418, process flow proceeds to operation 1420.

In one embodiment, at operation 1420, upon user confirmation of identification of a correct key blank, the one or more images of the particular cut key are annotated with the key blank part number corresponding to the correct key blank.

In one embodiment, upon confirmation that one of the matching key blank part numbers is the correct key blank part number, a user interface feedback acquisition module obtains the correct key blank part number, and also collects the user cut key images that were provided to the key blank identification system by the user. The correct key blank part number and the user cut key images are then passed to an image annotation module.

In one embodiment, the user cut key images, including the cut key first surface image and the cut key second surface image are stored in a portion of a key image database. In one embodiment, for each pair of cut key images in the key image database, an interface on the backend of key blank identification application allows for manual selection and/or automatic assignment of the correct key blank part number from a listing of the matched key blank part numbers in the matched key blank part number data. In one embodiment, upon selection/assignment of the correct key blank part number, the cut key first surface image and the cut key second surface image are annotated with the correct key blank part number. In one embodiment, the user cut key images and their corresponding correct key blank part number are stored in the key image database as annotated key image data.

In one embodiment, the one or more images of the particular cut key are annotated with the key blank part number at operation 1420, process flow proceeds to operation 1422.

In one embodiment, at operation 1422, the annotated one or more images of the particular cut key are incorporated into the key blank identification training data for refinement of the trained key blank identification machine learning model

In various embodiments, annotating the user cut key images and storing the newly annotated images in the key image database allows the trained key blank identification machine learning model to become more intelligent over time. For example, the newly generated annotated key image data can then be incorporated into the key blank identification training data for further refinement of the machine learning models.

In one embodiment, once the annotated one or more images of the particular cut key are incorporated into the key blank identification training data at operation 1422, process flow proceeds to operation 1424.

In one embodiment, at operation 1424, the refined key blank identification machine learning model is utilized to identify unique key blank part numbers that correspond with a plurality of cut keys.

In various embodiments, the ability of the method and system disclosed herein to refine the trained key blank identification machine learning model over time, based on the feedback received from users, particularly feedback relevant to keys that were not previously in the system, ensures that the key image database is continuously kept up to date with keys that have been newly introduced to the market. Further, the incorporation of the user cut key images into the key image database provides the machine learning model with additional visual data points, which helps to strengthen the accuracy of the results generated by the trained key blank identification machine learning model. Consequently, the refined trained key blank identification machine learning model is able to more rapidly and accurately identify the key blank part numbers that correspond with a wide variety of cut keys that were previously unknown to the system.

In one embodiment, once the unique key blank part numbers that correspond with a plurality of cut keys are identified at operation 1424, process flow proceeds to END operation 1426 where process 1400 is exited to await new data.

As noted above, in various embodiments, the technical solution disclosed herein includes a method and system for identification of key blank part numbers using machine learning models, which provides a user with a powerful tool to rapidly, easily, and accurately identify key blank part numbers that match with any number of uniquely cut keys. The system and method disclosed herein eliminates the need for reliance on outdated key blank manufacturing books, bulky and expensive equipment, and error-prone guesswork, resulting in major benefits for lock and key businesses, in the form of reduced overhead costs, more efficient use of human resources, and increased reputation among customers.

Consequently, the embodiments disclosed herein are directed to providing technical solutions to long-standing technical problems associated with identifying physical key blanks that correspond with uniquely cut keys to allow lock and key professionals to duplicate cut keys in a more efficient manner.

Additionally, the disclosed method and system for rapidly, easily, efficiently, and accurately identifying key blank part numbers that match with individual uniquely cut keys, including keys that are newly introduced to the market over time, requires a specific detailed process with clearly defined operations for training and refining machine learning models to identify key blank part numbers, and as such, does not encompass, embody, or preclude other forms of innovation in the area of key blank part number identification. Further, the disclosed embodiments of systems and methods for rapidly, easily, efficiently, and accurately identifying key blank part numbers that match with individual uniquely cut keys, including keys that are newly introduced to the market over time are not abstract ideas for at least several reasons.

First, utilizing machine learning models to rapidly, easily, efficiently, and accurately identify key blank part numbers that match with individual uniquely cut keys, including keys that are newly introduced to the market over time is not an abstract idea because it is not merely an idea in and of itself. For example, the process cannot be performed mentally or using pen and paper, as there are an enormous number of key blanks of differing shapes, styles, and millings available on the market, with significant number of new key blanks being introduced to the market every year. Training a system to process each and every visual data point of every key blank and cut key available on the market to rapidly and correctly identify key blank part numbers is a process that cannot feasibly be performed by the human mind, even with pen and paper to assist the human mind and even with unlimited time.

Second, utilizing machine learning models to rapidly, easily, efficiently, and accurately identify key blank part numbers that match with individual uniquely cut keys, including keys that are newly introduced to the market over time is not a fundamental economic practice (e.g., is not merely creating a contractual relationship, hedging, mitigating a settlement risk, etc.).

Third, utilizing machine learning models to rapidly, easily, efficiently, and accurately identify key blank part numbers that match with individual uniquely cut keys, including keys that are newly introduced to the market over time is not merely a method of organizing human activity (e.g., managing a game of bingo). Rather, in the disclosed embodiments, the method and system for utilizing machine learning models to rapidly, easily, efficiently, and accurately identify key blank part numbers that match with individual uniquely cut keys provides a tool that significantly improves the lock and key industry. Through the disclosed embodiments, lock and key professionals, as well as other individuals, are provided with a tool to help them more rapidly and accurately identify key blank part numbers associated with cut keys, which ensures reduction of overhead costs, more efficient use of human resources, and increased reputation among customers. As such, the method and system disclosed herein is not an abstract idea, and also serves to integrate the ideas disclosed herein into practical applications.

Fourth, although mathematics may be used to implement the embodiments disclosed herein, the systems and methods disclosed and claimed herein are not abstract ideas because the disclosed systems and methods are not simply a mathematical relationship/formula.

It should be noted that the language used in the specification has been principally selected for readability, clarity, and instructional purposes, and may not have been selected to delineate or circumscribe the inventive subject matter. Accordingly, the disclosure of the present invention is intended to be illustrative, but not limiting, of the scope of the invention, which is set forth in the claims below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for identifying key blank part numbers comprising:
providing a user with a user interface to a key blank identification system;
receiving one or more images of a cut key from the user through the user interface of the key blank identification system;
providing the one or more images of the cut key to a trained key blank identification machine learning model;
using the trained key blank identification machine learning model, identifying one or more key blank part numbers for one or more key blanks that match the cut key;
based on the identified one or more key blank part numbers, retrieving one or more images of the one or more matching key blanks from a key image database;
displaying the one or more images of the one or more matching key blanks and the corresponding matched key blank part numbers to the user through the user interface of the key blank identification system; and
providing the user with one or more mechanisms to obtain one or more physical key blanks corresponding to one or more of the matched key blank part numbers.

2. The computing system implemented method of claim 1 wherein the key blank identification system includes an application provided to the user on a mobile device.

3. The computing system implemented method of claim 1 wherein the one or more images of the cut key received from the user include:
an image of a first surface of the cut key; and
an image of a second surface of the cut key.

4. The computing system implemented method of claim 1 wherein the trained key blank identification machine learning model utilizes one or more image similarity algorithms to identify similarities between images of cut keys and images of key blanks, and further wherein the one or more similarity algorithms are selected from the group of image similarity algorithms consisting of:
Siamese Neural Networks; and
Convolutional Neural Networks.

5. The computing system implemented method of claim 1 wherein the trained key blank identification machine learning model utilizes one or more weighting parameters to rank potential key blank matches, and further wherein similarities between portions of key images depicting the key bottom are weighted more heavily than similarities between portions of key images depicting the key head.

6. The computing system implemented method of claim 5 wherein similarities between portions of key images depicting the key bottom are weighted at 90% and similarities between portions of key images depicting the key head are weighted at 10%.

7. The computing system implemented method of claim 1 wherein upon displaying the one or more images of the one or more matching key blanks and the corresponding matching key blank part numbers to the user:
confirmation as to whether one of the matched key blank part numbers is the correct key blank part number is requested from the user; and
confirmation that one of the matched key blank part numbers is the correct key blank part number is received from the user.

8. The computing system implemented method of claim 7 wherein upon receiving confirmation that one of the matched key blank part numbers is the correct key blank part number, one or more images in the key image database are annotated with the correct key blank part number.

9. The computing system implemented method of claim 7 wherein upon receiving confirmation that one of the matched key blank part numbers is the correct key blank part number, the user is provided with one or more mechanisms to obtain one or more physical key blanks corresponding to the correct key blank part number.

10. The computing system implemented method of claim 9 wherein upon providing the user with one or more mechanisms to obtain one or more physical key blanks corresponding to the correct key blank part number:
at least one of the physical key blanks corresponding to the correct key blank part number is obtained by the user; and
at least one of the obtained physical key blanks is cut by the user to produce a duplicate of the cut key.

11. A computing system implemented method for identifying key blank part numbers comprising:
aggregating a plurality of images of one or more cut keys;
aggregating a plurality of images of one or more key blanks, wherein each of the key blanks correspond to at least one of the one or more cut keys;
generating key blank identification training data based on the plurality of images of one or more cut keys and the plurality of images of one or more key blanks;
generating a trained key blank identification machine learning model by training one or more machine learning models to identify key blanks using the key blank identification training data;
receiving, by the trained key blank identification machine learning model, one or more images of a particular cut key from a user through a user interface of a key blank identification system;
using the trained key blank identification machine learning model, identifying one or more key blank part numbers for one or more key blanks that match the particular cut key;
based on the identified one or more key blank part numbers, retrieving one or more images of the one or more matching key blanks from a key image database;
displaying the one or more images of the one or more matching key blanks and the corresponding key blank part numbers to the user through a user interface of the key blank identification system;
receiving user feedback from the user through the user interface of the key blank identification system;
upon user confirmation of identification of a correct key blank, annotating the one or more images of the particular cut key with the key blank part number corresponding to the correct key blank;
incorporating the user feedback into the key blank identification training data to generate a refined trained key blank identification machine learning model; and
utilizing the refined key blank identification machine learning model to identify unique key blank part numbers that correspond with a plurality of cut keys.

12. The computing system implemented method of claim 11 wherein generating key blank identification training data includes annotating one or more images of the plurality of images of cut keys with a unique key blank part number.

13. The computing system implemented method of claim 11 wherein the one or more images of the cut key received from the user include:
an image of a first surface of the cut key; and
an image of a second surface of the cut key.

14. The computing system implemented method of claim 11 wherein the trained key blank identification machine learning model utilizes one or more image similarity algorithms to identify similarities between images of cut keys and images of key blanks, and further wherein the one or more similarity algorithms are selected from the group of image similarity algorithms consisting of:
Siamese Neural Networks; and
Convolutional Neural Networks.

15. The computing system implemented method of claim 11 wherein the trained key blank identification machine learning model utilizes one or more one or more weighting parameters to rank potential key blank matches.

16. The computing system implemented method of claim 15 wherein similarities between portions of key images depicting the key bottom are weighted more heavily than similarities between portions of key images depicting the key head.

17. The computing system implemented method of claim 16 wherein similarities between portions of key images depicting the key bottom are weighted at 90% and similarities between portions of key images depicting the key head are weighted at 10%.

18. The computing system implemented method of claim 11 wherein the user feedback indicates whether one of the one or more matching key blank part numbers is a correct key blank part number.

19. The computing system implemented method of claim 18 wherein upon user indication of a correct key blank part number, the one or more images of the particular cut key are annotated with the correct key blank part number and stored in the key image database.

20. A system for identifying key blank part numbers comprising:
a key image database;
one or more machine learning models;
a key blank identification application;
at least one processor; and
at least one memory, the at least one memory including instructions that when executed by the at least one processor perform a process, the process including:
aggregating a plurality of images of one or more cut keys and storing the plurality of images of one or more cut keys in the key image database;
aggregating a plurality of images of one or more key blanks, wherein each of the key blanks correspond to at least one of the one or more cut keys, and storing the plurality of images of one or more key blanks in the key image database;
generating key blank identification training data by annotating one or more images of the plurality of images of cut keys with a unique key blank part number;
generating a trained key blank identification machine learning model by training the one or more machine learning models to identify key blanks using the key blank identification training data, wherein the trained key blank identification machine learning model utilizes one or more image similarity algorithms to identify similarities between images of cut keys and images of key blanks;
receiving, by the trained key blank identification machine learning model, an image of a first surface of a particular cut key and an image of a second surface of the particular cut key from a user through a user interface of the key blank identification application;
using the trained key blank identification machine learning model, identifying one or more key blank part numbers for one or more key blanks that match the key shown in the images of the particular cut key;
based on the identified one or more key blank part numbers, retrieving one or more images of the one or more matching key blanks from the key image database;
displaying the one or more images of the one or more matching key blanks and the corresponding key blank part numbers to the user through a user interface of the key blank identification application;
requesting feedback from the user through the user interface of the key blank identification application, wherein the feedback indicates whether one of the one or more matching key blank part numbers is a correct key blank part number;
upon user indication of a correct key blank part number, annotating the one or more images of the particular cut key with the correct key blank part number and storing the one or more annotated images in the key image database;
incorporating the one or more annotated images of the particular cut key into the key blank identification training data to generate a refined trained key blank identification machine learning model; and
utilizing the refined key blank identification machine learning model to identify unique key blank part numbers that correspond with a plurality of cut keys.
